(19) United States
(12) Patent Application Publication
(10) Pub. No.: US 2016/0119943 A1
(43) Pub. Date: Apr. 28, 2016

(54) Discontinuous Reception in Communications

(71) Applicant: NOKIA SOLUTIONS AND NETWORKS OY, Espoo (FI)

(72) Inventors: Rossella DE BENEDITTIS, Ulm (DE); Woonhee HWANG, Espoo (FI)

(21) Appl. No.: 14/890,622

(22) PCT Filed: May 14, 2013
(86) PCT No.: PCT/EP2013/059935

§ 371 Date: Nov. 12, 2015

(51) Int. Cl. H04W 72/12; H04W 76/04

(52) U.S. Cl. CPC H04W 72/1257; H04W 76/048; H04W 72/1289

(57) ABSTRACT

A method for transmission control in a communications system is disclosed, the method including transmitting, from a network apparatus to a user terminal, an indication to tell the user terminal to refrain from sending a resource scheduling request until a predefined event is detected in the user terminal. The transmitted indication may include e.g. a request to carry out an enforced periodical global cell identity CGI measurement.

### FIELD OF THE INVENTION

The exemplary and non-limiting embodiments of this invention relate generally to wireless communications networks, and more particularly to measuring and reporting performed by a user terminal.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Discontinuous reception (DRX) refers to saving battery power in mobile stations by periodically/automatically switching a mobile station receiver on and off.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, apparatuses, and a computer program product as defined in the independent claims. Further embodiments of the invention are disclosed in the dependent claims.

An aspect of the invention relates to a method for transmission control in a communications system, the method comprising transmitting, from a network apparatus to a user terminal, an indication in order to tell the user terminal to refrain from sending a resource scheduling request until a predefined event is detected in the user terminal.

A further aspect of the invention relates to a method for transmission control in a communications system, the method comprising receiving, in a user terminal from a network apparatus, an indication telling the user terminal to refrain from sending resource scheduling requests until a predefined event is detected in the user terminal; and refraining from sending resource scheduling requests until the predefined event is detected in the user terminal.

A still further aspect of the invention relates to a first apparatus comprising at least one processor; and at least one memory including a computer program code, wherein the at least one memory and the computer program code are configured to, with the at least one processor, cause the first apparatus to transmit, to a user terminal, an indication in order to tell the user terminal to refrain from sending a resource scheduling request until a predefined event is detected in the user terminal.

A still further aspect of the invention relates to a second apparatus comprising at least one processor; and at least one memory including a computer program code, wherein the at least one memory and the computer program code are configured to, with the at least one processor, cause the second apparatus to receive, from a network apparatus, an indication telling to refrain from sending resource scheduling requests until a predefined event is detected in the second apparatus; refrain from sending resource scheduling requests until the predefined event is detected in the second apparatus.

A still further aspect of the invention relates to a computer program stored in a computer readable medium, comprising program code means adapted to perform any of the method steps when the program is run on a processor.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 shows a simplified block diagram illustrating exemplary system architecture;

FIG. 2 shows a simplified block diagram illustrating exemplary apparatuses;

FIG. 3 shows a messaging diagram illustrating an exemplary messaging event according to an embodiment of the invention;

FIG. 4 shows a schematic diagram of a flow chart according to an exemplary embodiment of the invention;

FIG. 5 shows a schematic diagram of a flow chart according to another exemplary embodiment of the invention.

### DETAILED DESCRIPTION OF SOME EMBODIMENTS

An exemplary embodiment addresses UE measurements in combination with DRX (discontinuous reception) in LTE RAN. DRX may be used for UE power saving as UE does not need to listen to a serving cell during DRX inactive periods, if there is no uplink or downlink data activity.

Another application of DRX is for requesting UE to read and report a global cell identity (CGI) of a given cell. This measurement may be referred to as a “ReportCGI” measurement.

Detection of a cell CGI implies that UE reads and decodes a system information block (SIB) carrying CGI from an indicated cell. In order for the measurement to succeed, UE listens to that cell at least for a time interval corresponding to the repetition of a relevant SIB. Such a time interval, whatever the technology of the cell to measure is, is greater than the 6 ms offered by regular measurement gap patterns, and is therefore affordable with DRX only.

During the DRX inactive periods UE is allowed to switch-off its receiver for power saving or, if a ReportCGI measurement has been requested, to turn its receiver to the indicated cell for measuring a relevant SIB of the cell. Yet, if during the measurement there is a need for sending any data (signalling or user traffic), UE asks a serving cell for resources, thus interrupting the measurement. Such an interruption actually reduces the time that UE is supposed to devote for SIB reading, making the measurement impossible. Contrary to regular measurement gap patterns where UE is not allowed to transmit, the DRX inactive period may be interrupted any time if UE needs resources. There are situations where measuring and reporting a neighbour cell CGI may save a UE call. This is, for example, the case when a neighbour H(e)NB with a physical cell identity (PCI) shared with other H(e)NBs at the same carrier frequency, i.e. with a potential for a “PCI confusion”, is reported by UE as a candidate for a handover. Before starting handover preparation to that target, the serving cell has to resolve the PCI confusion, i.e. it has to know CGI of H(e)NB PCI that has been reported by UE and this identity resolution should happen fast enough for avoiding a call drop.

A ReportCGI measurement requires either a long DRX cycle, or UE autonomous measurement gaps.

A DRX cycle is composed of active periods and of idle periods during which UE performs the requested measurement. Yet, the inactive periods of DRX may be interrupted any time due to data activity: if on one hand the serving eNB may temporarily buffer downlink data stopping their transmission for a time interval needed by UE to perform the requested measurement, there is no way to stop UE from sending a scheduling request, if UE has data to send. The interruption of the idle periods may actually make the ReportCGI measurement impossible.

With autonomous gaps, it is UE which decides when to stop receiving and transmitting from/to the serving cell for making the measurement.

As the serving cell does not know when UE stops the reception, the serving cell is not able to enforce the ReportCGI measurement, with a consequence that some DL data may be lost. On the other hand, it is not clear whether and when UE refrains from sending its scheduling requests during the course of the ReportCGI measurement. If the scheduling requests are sent with a periodicity higher than the repetition period of the system information carrying the requested CGI, the ReportCGI measurement may never succeed.

An exemplary embodiment enables enforcing UE measurements during DRX inactivity periods. In an exemplary embodiment, eNB is able to tell UE if UE has to give priority to a given measurement with reference to uplink data activity, i.e. whether UE has to refrain from sending a scheduling request as long as a given measurement is running or a respective supervision timer is running.

In a first exemplary embodiment, this indication may be provided at a RRC level when configuring the ReportCGI measurement. For example, ReportConfigEUTRA IE may be extended as follows (bold text):

| | |
|---|---|
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6-r10 | SEQUENCE { |
| a6-Offset-r10 | INTEGER (−30..30), |
| a6-ReportOnLeave-r10 | BOOLEAN |
| } | |
| }, | |
| hysteresis | Hysteresis, |
| timeToTrigger | TimeToTrigger |
| }, | |
| periodical | SEQUENCE { |
| purpose | ENUMERATED { |
| | reportStrongestCells, |
| reportCGI} | |
| } | |
| }, | |

| | |
|---|---|
| triggerQuantity | ENUMERATED {rsrp, rsrq}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, |
| infinity}, | |
| ..., | |

| | | |
|---|---|---|
| [[ si-RequestForHO-r9 | ENUMERATED {setup} | OPTIONAL, -- Cond |
| reportCGI | | |
| ue-RxTxTimeDiffPeriodical-r9 | ENUMERATED {setup} | OPTIONAL -- Need |
| OR | | |
| ]], | | |
| [[ includeLocationInfo-r10 | ENUMERATED {true} | OPTIONAL, -- Need |
| OR | | |
| reportAddNeighMeas-r10 | ENUMERATED {setup} | OPTIONAL -- Need |
| OR | | |
| ]] | | |

| | |
|---|---|
| [[ enforceCGI | ENUMERATED {enforcedCGI_ON, enfocedCGI_OFF} |
| OPTIONAL Cond reportCGI, | |
| ]] | |
| } | |

If requested to do a “ReportCGI Enforced” periodical measurement, UE does not ask for resources during the measurement time period, i.e. till the respective measurement is reported. This may take a T321 timer time at maximum.

Or, UE may refrain from asking resources for a pre-defined time interval. This time interval may be linked to a respective SIB (i.e. to SIB carrying the requested global cell identity) periodicity or may be directly communicated by the serving cell when activating the measurement (e.g. as an additional parameter in ReportConfigEUTRA IE). For example, a timer value may be derived from a repetition period of a relevant SIB that UE is requested to read for performing a CGI measurement.

In addition, UE may possibly autonomously resume sending a scheduling request, whenever a pre-defined high level event happens (e.g. it has to send a ReportCGI measurement result, a mobility measurement report or an RRC or NAS message).

According to the first exemplary embodiment, the detection of the request is protected at RRC level. However, the enforcement may only be used in combination with a ReportCGI measurement.

In a second exemplary embodiment, the indication may be provided via a new MAC control element, e.g. enforce DRX inactive period (EDRX), which is sent by the serving eNB to enable or disable the scheduling request by UE during the ReportCGI measurement period.

In the second exemplary embodiment, a potential realization of EDRX MAC CE may be a MAC PDU sub-header with a logical channel identifier (LCID) value from a reserved range, fixed size and one single field indicating whether the DRX inactive period should or should not be enforced.

If UE receives EDRX MAC CE indicating enforcement, UE does not ask for resources during the ReportCGI measurement.

In addition, UE may possibly autonomously resume sending a scheduling request, whenever a pre-defined high level event happens (e.g. it has to send a ReportCGI measurement result, a mobility measurement report or an RRC or NAS message).

In the second exemplary embodiment, the request may be used for any present/future purpose which may need it. However, the detection of the request may be less sure; eNB needs to send a “disable” command which may only be sent during the DRX active periods.

An exemplary embodiment may be used with or without DRX, for example, when UE is allowed to use autonomous gaps, and without any reference to specific measurement, e.g. for reducing UE power consumption or generated interference.

An exemplary embodiment relates to LTE-A and in particular to UE measurements in combination with DRX. During the DRX idle period UE may switch off its receiver in order to reduce power consumption or, if required, perform a CGI measurement. In a situation where during this period UE needs to transmit data, the CGI measurement procedure is interrupted as UE transmits a resource scheduling request. The measurement is then performed at a future time. In an exemplary embodiment, UE is given a priority to perform CGI reading from neighbour cells SIB and not to interrupt the measurement due to UL data transmission request from UE or other reasons. In an exemplary embodiment, either RRC signaling or MAC level signaling is used to indicate to UE that UE should perform CGI reporting with higher priority than getting out of idle period to do data transmission (i.e. enforces ReportCGI reporting as higher priority). Once signaled to enforce CGI reporting as higher priority, UE has to perform measurement for a time duration that is either predefined in or signaled to UE.

During the DRX inactive periods UE is allowed to switch off its receiver for power saving or, if a ReportCGI measurement has been requested, to turn its receiver onto the indicated cell for measuring the relevant SIB. Yet if during the ReportCGI measurement there is a need for sending any data (signalling or user traffic), UE asks the serving cell for resources thus interrupting the CGI measurement. There are situations where measuring and reporting a neighbour cell CGI may save the UE call. In an exemplary embodiment, eNB is able to tell UE if UE should give priority to a given measurement (e.g. ReportCGI) with reference to uplink data activity, i.e. whether UE should refrain from sending scheduling request as long as a given measurement is running or a respective supervision timer is running.

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support UE measurements and reporting. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (or LTE-A) (long term evolution (advanced long term evolution)) network elements, without restricting the embodiment to such an architecture, however. The embodiments described in these examples are not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

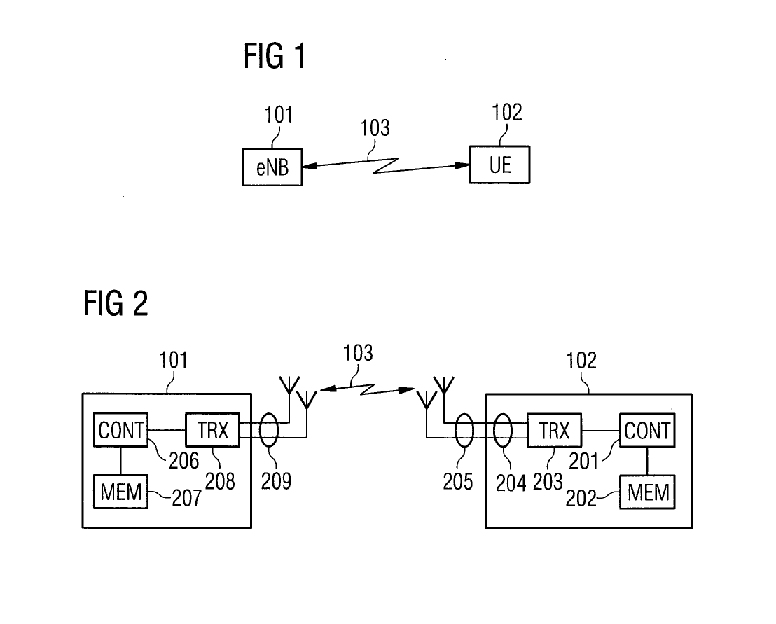

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for measuring and reporting, are irrelevant to the actual invention. Therefore, they need not to be discussed in more detail here.

The exemplary radio system of FIG. 1 comprises a network node 101 of a network operator. The network node 101 may include e.g. an LTE base station (eNB), radio network controller (RNC), or any other network element, or a combination of network elements. The network node 101 may be connected to one or more core network (CN) elements (not shown in FIG. 1) such as a mobile switching centre (MSC), MSC server (MSS), mobility management entity (MME), gateway GPRS support node (GGSN), serving GPRS support node (SGSN), home location register (HLR), home subscriber server (HSS), visitor location register (VLR). In FIG. 1, the radio network node 101 that may also be called eNB (enhanced node-B, evolved node-B) or network apparatus of the radio system, hosts the functions for radio resource management in a public land mobile network. FIG. 1 shows one or more user equipment 102 located in the service area of the radio network node 101. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 1, the user equipment 102 is capable of connecting to the radio network node 101 via a connection 103.

FIG. 2 is a block diagram of an apparatus according to an embodiment of the invention. FIG. 2 shows a user equipment 102 located in the area of a radio network node 101. The user equipment 102 is configured to be in connection with the radio network node 101. The user equipment or UE 102 comprises a controller 201 operationally connected to a memory 202 and a transceiver 203. The controller 201 controls the operation of the user equipment 102. The memory 202 is configured to store software and data. The transceiver 203 is configured to set up and maintain a wireless connection 103 to the radio network node 101. The transceiver 203 is operationally connected to a set of antenna ports 204 connected to an antenna arrangement 205. The antenna arrangement 205 may comprise a set of antennas. The number of antennas may be one to four, for example. The number of antennas is not limited to any particular number. The user equipment 102 may also comprise various other components, such as a user interface, camera, and media player. They are not displayed in the figure due to simplicity. The radio network node 101, such as an LTE base station (eNode-B, eNB) comprises a controller 206 operationally connected to a memory 207, and a transceiver 208. The controller 206 controls the operation of the radio network node 101. The memory 207 is configured to store software and data. The transceiver 208 is configured to set up and maintain a wireless connection to the user equipment 102 within the service area of the radio network node 101. The transceiver 208 is operationally connected to an antenna arrangement 209. The antenna arrangement 209 may comprise a set of antennas. The number of antennas may be two to four, for example. The number of antennas is not limited to any particular number. The radio network node 101 may be operationally connected (directly or indirectly) to another network element (not shown in FIG. 2) of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 101, 102 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 101, 102 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 202, 207 may include volatile and/or non-volatile memory and typically stores content, data, or the like. For example, the memory 202, 207 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

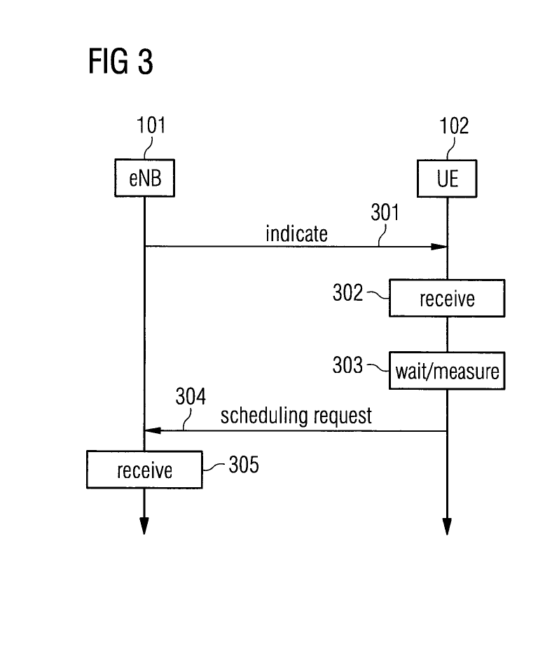

The signalling chart of FIG. 3 illustrates the required signalling. In the example of FIG. 3, a network node 101 (which may comprise e.g. a LTE-capable base station (eNode-B, eNB)) may transmit an indication 301 to a user terminal 102 (UE), for configuring UE 102 to refrain from sending a resource scheduling request until a predefined event is detected in the user terminal 102. The indication may comprise a request to carry out an enforced periodical global cell identity CGI measurement. The indication may be provided at a radio resource control RRC level when configuring a ReportCGI measurement. In item 302, the indication 302 is received in the user terminal 102. In item 303, the user terminal may perform the CGI measurement, wherein the predefined event may comprise the user terminal completing and reporting a periodical global cell identity CGI measurement regarding uplink data activity of a cell. The predefined event may comprise an expiration of a timer, wherein, in item 303, the user terminal may refrain from sending resource scheduling request until the expiration of the timer. Alternatively, the indication 301 may be provided via a MAC control element which is sent by a serving base station 101 to enable or disable resource scheduling requests in the user terminal 102 during the ReportCGI measurement period. The predefined event may also comprise a pre-defined high level event, e.g. the user terminal transmitting the ReportCGI measurement result or a mobility measurement report to the network apparatus. In item 304, the user terminal 102 may transmit a resource scheduling request 304 to the network node 101 (after detecting a predefined event in item 303). In item 305, the network node 101 may receive the resource scheduling request 304 from the user terminal 102.

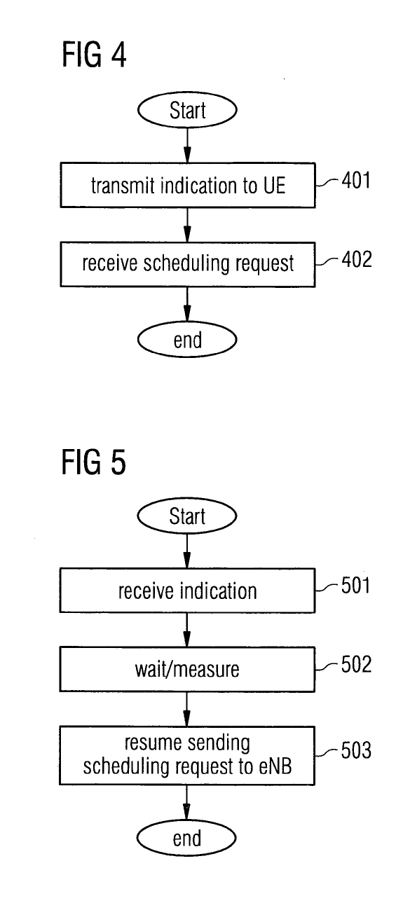

FIG. 4 is a flow chart illustrating an exemplary embodiment. The apparatus 101, which may comprise e.g. a network element (network node 101, e.g. a LTE base station, eNB) transmits, in item 401, to another network element (network node 102, e.g. a user terminal, UE) an indication for configuring UE 102 to refrain from sending a resource scheduling request until a predefined event is detected in the user terminal 102. The indication may comprise a request to carry out an enforced periodical global cell identity CGI measurement. The indication may be provided at a radio resource control RRC level when configuring a ReportCGI measurement. The predefined event may comprise the user terminal completing and reporting a periodical global cell identity CGI measurement regarding an indicated cell. The predefined event may also comprise an expiration of a timer, wherein the user terminal may refrain from sending resource scheduling request until the expiration of the timer. Alternatively, the indication may be provided 401 via a MAC control element which is sent by a serving base station 101 to enable or disable resource scheduling requests in the user terminal 102. The predefined event may also comprise a pre-defined high level event, e.g. the user terminal transmitting a mobility measurement report to the network apparatus. In item 402, the network node 101 may receive a resource scheduling request from the user terminal 102 (after a predefined event has been detected in the user terminal 102).

FIG. 5 is a flow chart illustrating an exemplary embodiment. The apparatus 102, which may comprise e.g. a network element (network node, e.g. a user terminal, UE) receives, in item 501, from a network apparatus 101 (which may comprise e.g. a LTE base station eNB 101) an indication for configuring UE 102 to refrain from sending a resource scheduling request until a predefined event is detected in the user terminal 102. The indication may comprise a request to carry out an enforced periodical global cell identity CGI measurement. The indication may be provided at a radio resource control RRC level when configuring a ReportCGI measurement. In item 502, the user terminal may perform the CGI measurement, wherein the predefined event may comprise the user terminal completing and reporting a periodical global cell identity CGI measurement regarding an indicated cell. The predefined event may comprise an expiration of a timer, wherein, in item 502, the user terminal may refrain from sending resource scheduling request until the expiration of the timer. Alternatively, the indication may be provided via a MAC control element which is sent by a serving base station 101 to enable or disable resource scheduling requests in the user terminal 102 during the ReportCGI measurement period. The predefined event may also comprise a pre-defined high level event, e.g. the user terminal transmitting a mobility measurement report to the network apparatus. In item 503, the user terminal 102 may transmit a resource scheduling request to the network node 101 (after detecting a predefined event in item 502).

Thus, according to an exemplary embodiment, there is provided a method for transmission control in a communications system, comprising transmitting, from a network apparatus to a user terminal, an indication in order to tell the user terminal to refrain from sending a resource scheduling request until a predefined event is detected in the user terminal.

According to another exemplary embodiment, the indication comprises a request to carry out an enforced periodical global cell identity CGI measurement.

According to yet another exemplary embodiment, the indication is provided at a radio resource control RRC level when configuring a ReportCGI measurement.

According to yet another exemplary embodiment, the predefined event comprises the user terminal completing and reporting a periodical global cell identity CGI measurement regarding an indicated cell.

According to yet another exemplary embodiment, the predefined event comprises an expiration of a timer.

According to yet another exemplary embodiment, the predefined event comprises an expiration of a timer, wherein the timer is linked to a respective system information block SIB carrying a requested global cell identity CGI.

According to yet another exemplary embodiment, the predefined event comprises an expiration of a timer, wherein the timer is directly communicated by a serving cell when activating a measurement.

According to yet another exemplary embodiment, the timer is communicated as an additional parameter in a ReportConfigEUTRA IE request.

According to yet another exemplary embodiment, the indication is provided via a MAC control element which is sent by a serving base station to enable or disable resource scheduling requests in the user terminal in discontinuous transmission DRX inactive periods during a global cell identity CGI measurement.

According to yet another exemplary embodiment, the MAC control element comprises an Enforce DRX Inactive Periods EDRX control element.

According to yet another exemplary embodiment, the Enforce DRX Inactive Periods EDRX control element comprises a MAC PDU subheader with a logical channel identifier LCID value from a reserved range, fixed size and a single field indicating whether a DRX inactive period is to be enforced or not.

According to yet another exemplary embodiment, the method comprises telling the user terminal to refrain from sending resource scheduling requests until a predefined event is detected in the user terminal.

According to yet another exemplary embodiment, the predefined event comprises a pre-defined high level event.

According to yet another exemplary embodiment, the pre-defined high level event comprises the user terminal transmitting a requested CGI measurement result, a mobility measurement report, an RRC message or a NAS message to the network apparatus.

According to yet another exemplary embodiment, there is provided a method for transmission control in a communications system, comprising receiving, in a user terminal from a network apparatus, an indication telling the user terminal to refrain from sending resource scheduling requests until a predefined event is detected in the user terminal; refraining from sending resource scheduling requests until the predefined event is detected in the user terminal.

According to yet another exemplary embodiment, there is provided a first apparatus comprising at least one processor; and at least one memory including a computer program code, wherein the at least one memory and the computer program code are configured to, with the at least one processor, cause the first apparatus to transmit, to a user terminal, an indication in order to tell the user terminal to refrain from sending a resource scheduling request until a predefined event is detected in the user terminal.

According to yet another exemplary embodiment, the at least one memory and the computer program code are configured to, with the at least one processor, cause the first apparatus to perform any of the method steps.

According to yet another exemplary embodiment, there is provided a second apparatus comprising at least one processor; and at least one memory including a computer program code, wherein the at least one memory and the computer program code are configured to, with the at least one processor, cause the second apparatus to receive, from a network apparatus, an indication telling to refrain from sending resource scheduling requests until a predefined event is detected in the second apparatus; refrain from sending resource scheduling requests until the predefined event is detected in the second apparatus.

According to yet another exemplary embodiment, the at least one memory and the computer program code are configured to, with the at least one processor, cause the second apparatus to, in response receiving an EDRX MAC CE indicating enforcement, refrain from sending resource scheduling requests in DRX inactive periods during a global cell identity CGI measurement.

According to yet another exemplary embodiment, the at least one memory and the computer program code are configured to, with the at least one processor, cause the second apparatus to resume sending a resource scheduling request, if a pre-defined high level event is detected in the second apparatus.

According to yet another exemplary embodiment, there is provided a computer program stored in a computer readable medium, comprising program code means adapted to perform any of the method steps when the program is run on a processor.

The steps/points, signalling messages and related functions described above in FIGS. 1 to 5 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The server operations illustrate a procedure that may be implemented in one or more physical or logical entities. The signalling messages are only exemplary and may even comprise several separate messages for transmitting the same information. In addition, the messages may also contain other information.

It will be obvious to a person skilled in the art that, as the technology advances, the inventive concept can be implemented in various ways. The invention and its embodiments are not limited to the examples described above but may vary within the scope of the claims.

1. A method for transmission control in a communications system, characterized by
transmitting, from a network apparatus to a user terminal, an indication in order to tell the user terminal to refrain from sending a resource scheduling request until a predefined event is detected in the user terminal.

2. A method according to claim 1, characterized in that the indication comprises a request to carry out an enforced periodical global cell identity CGI measurement.

3. A method according to claim 1, characterized in that the indication is provided at a radio resource control RRC level when configuring a ReportCGI measurement.

4. A method according to claim 1, characterized in that the predefined event comprises the user terminal completing and reporting a periodical global cell identity CGI measurement regarding an indicated cell.

5. A method according to claim 1, characterized in that the predefined event comprises an expiration of a timer.

6. A method according to claim 1, characterized in that the predefined event comprises an expiration of a timer, wherein the timer is linked to a respective system information block SIB carrying a requested global cell identity CGI.

7. A method according to claim 1, characterized in that the predefined event comprises an expiration of a timer, wherein the timer is directly communicated by a serving cell when activating a measurement.

8. A method according to claim 7, characterized in that the timer is communicated as an additional parameter in a ReportConfigEUTRA IE request.

9. A method according to claim 1, characterized in that the indication is provided via a MAC control element which is sent by a serving base station to enable or disable resource scheduling requests in the user terminal in discontinuous transmission DRX inactive periods during a global cell identity CGI measurement.

10. A method according to claim 9, characterized in that the MAC control element comprises an Enforce DRX Inactive Periods EDRX control element.

11. A method according to claim 9, characterized in that the Enforce DRX Inactive Periods EDRX control element comprises a MAC PDU subheader with a logical channel identifier LCID value from a reserved range, fixed size and a single field indicating whether a DRX inactive period is to be enforced or not.

12. A method according to claim 9, characterized by telling the user terminal to refrain from sending resource scheduling requests until a predefined event is detected in the user terminal.

13. A method according to claim 1, characterized in that in that the predefined event comprises a pre-defined high level event.

14. A method according to claim 13, characterized in that the pre-defined high level event comprises the user terminal transmitting a requested CGI measurement result, a mobility measurement report, an RRC message or a NAS message to the network apparatus.

15. A method for transmission control in a communications system, characterized by
receiving, in a user terminal from a network apparatus, an indication telling the user terminal to refrain from sending resource scheduling requests until a predefined event is detected in the user terminal; refraining from sending resource scheduling requests until the predefined event is detected in the user terminal.

16. A first apparatus comprising at least one processor; and at least one memory including a computer program code, characterized in that the at least one memory and the computer program code are configured to, with the at least one processor, cause the first apparatus to
transmit, to a user terminal, an indication in order to tell the user terminal to refrain from sending a resource scheduling request until a predefined event is detected in the user terminal.

17. A first apparatus according to claim 16, characterized in that the at least one memory and the computer program code are configured to, with the at least one processor, cause the first apparatus to perform the method for transmission control in a communications system, characterized by transmitting, from a network apparatus to a user terminal, an indication in order to tell the user terminal to refrain from sending a resource scheduling request until a predefined event is detected in the user terminal, and further characterized in that the indication comprises a request to carry out an enforced periodical global cell identity CGI measurement.

18. A second apparatus comprising at least one processor; and at least one memory including a computer program code, characterized in that the at least one memory and the computer program code are configured to, with the at least one processor, cause the second apparatus to
receive, from a network apparatus, an indication telling to refrain from sending resource scheduling requests until a predefined event is detected in the second apparatus;
refrain from sending resource scheduling requests until the predefined event is detected in the second apparatus.

19. A second apparatus according to claim 18, characterized in that the at least one memory and the computer program code are configured to, with the at least one processor, cause the second apparatus to, in response receiving an EDRX MAC CE indicating enforcement, refrain from sending resource scheduling requests in DRX inactive periods during a global cell identity CGI measurement.

20. A second apparatus according to claim 18, characterized in that the at least one memory and the computer program code are configured to, with the at least one processor, cause the second apparatus to resume sending a resource scheduling request, if a pre-defined high level event is detected in the second apparatus.

21. A computer program stored in a computer readable medium, comprising program code means adapted to perform the steps of claim 1 when the program is run on a processor.
